(19) United States
(12) Patent Application Publication
(10) Pub. No.: US 2025/0337124 A1
(43) Pub. Date: Oct. 30, 2025

(54) STORAGE CELL

(71) Applicant: TOYOTA JIDOSHA KABUSHIKI KAISHA, Toyota-shi (JP)

(72) Inventors: Masato ONO, Nagoya-shi (JP); Masahiro Ishizuka, Toyota-shi (JP); Atsushi Sugihara, Toyota-shi (JP); Yuka Yokoi, Nagoya-shi (JP); Ryosuke Sato, Toyota-shi (JP); Keitaro Machida, Hamamatsu-shi (JP); Tatsuya Yamamoto, Toyohashi-shi (JP)

(73) Assignee: TOYOTA JIDOSHA KABUSHIKI KAISHA, Toyota-shi (JP)

(21) Appl. No.: 19/088,116

(22) Filed: Mar. 24, 2025

(30) Foreign Application Priority Data
Apr. 30, 2024 (JP) 2024-073491

(51) Int. Cl. H01M 50/503; H01M 50/516; H01M 50/557

(52) U.S. Cl. CPC H01M 50/503; H01M 50/557; H01M 50/516

(57) ABSTRACT

A storage cell includes an electrode body having a strip-shaped electrode tab, a laminate film that accommodates the electrode body such that a part of the electrode tab is exposed, and an insulating coating portion that is provided on an end face of the electrode body on which the electrode tab is formed and covers a portion of the end face on which the electrode tab is not formed.

### CROSS-REFERENCE TO RELATED APPLICATION

This application claims priority to Japanese Patent Application No. 2024-073491 filed on Apr. 30, 2024, incorporated herein by reference in its entirety.

### BACKGROUND

### 1. Technical Field

The present disclosure relates to a storage cell.

### 2. Description of Related Art

For example, Japanese Unexamined Patent Application Publication (Translation of PCT application) No. 2023-502698 (JP 2023-502698 A) discloses a battery with a plurality of electrode body sets and a case that accommodates the electrode body sets. The electrode body sets include at least one electrode body.

### SUMMARY

An electrode body has a coated portion and an electrode tab. The coated portion is an area provided with an active material layer in an electrode foil of a cathode sheet or an anode sheet. The electrode tab is an area provided with no active material layer in the electrode foil of the cathode sheet or the anode sheet, that is, an uncoated area where the electrode foil is exposed. In general, an elongated belt-shaped electrode tab is formed on one side in a short-side direction of an elongated belt-shaped coating portion. The short-side direction of the coated portion corresponds to a first direction described below. Cathode electrode tabs are formed at one end portion in the first direction of the electrode body, and anode electrode tabs are formed at the other end portion in the first direction of the electrode body. In order to gather the electrode tabs, the electrode tabs are pressed down from both ends of the end face in the short-side direction of the electrode body. The short-side direction of the end face of the electrode body corresponds to a second direction described below. As a result, electrode foil of the electrode tabs is pulled from both ends in a longitudinal direction of the end face to a center portion in the longitudinal direction of the end face. The longitudinal direction of the end face corresponds to a third direction described below. As the electrode foil is pulled, the electrode foil is broken or wrinkled. Furthermore, the electrode foil in the cathode sheet or anode sheet is located on the end face of the electrode body. Therefore, when foreign matter adheres to the end face of the electrode body, it may cause a short-circuit in the electrode body.

The present disclosure has an object to restrain breakage and wrinkling of electrode foil and restrain a short circuit in the electrode body.

A storage cell according to an aspect of the present disclosure includes an electrode body having a strip-shaped electrode tab, a laminate film that accommodates the electrode body such that a part of the electrode tab is exposed, and an insulating coating portion that is provided on an end surface of the electrode body on which the electrode tab is formed and covers a portion of the end surface on which the electrode tab is not formed.

The electrode body may be formed so as to surround a periphery of a winding imaginary line. The electrode body may include a first end face and a second end face that are arranged in a direction in which the winding imaginary line extends. The electrode tab may protrude from the first end face in the direction in which the winding imaginary line extends. The electrode tab may be bent in a direction intersecting the direction in which the winding imaginary line extends.

The electrode tab may be bent in a direction intersecting the direction in which the imaginary winding line extends, at an exposed portion exposed from the laminate film. The storage cell may further include a current collecting terminal connected to a bent tip portion of the exposed portion.

The electrode tab may be bent in a direction intersecting the direction in which the winding imaginary line extends, at a portion where the electrode tab is covered by the laminate film. The electrode tab may be further bent at an exposed portion exposed from the laminate film. The storage cell may further include a current collecting terminal connected to a bent tip portion of the exposed portion.

At least one of a part of the electrode tab that is in contact with the laminate film and a portion of the laminate film that is in contact with the electrode tab may be subjected to rough surface processing.

According to the present disclosure, breakage and wrinkling of the electrode foil can be restrained, and a short circuit in the electrode body can be restrained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view that schematically shows a vehicle equipped with a storage device including a storage cell in an embodiment of the present disclosure;

FIG. 2 is a perspective view that schematically shows the storage cell in the embodiment of the present disclosure;

FIG. 3 is a front view of the storage cell in the embodiment of the present disclosure;

FIG. 4 is a sectional view taken along IV-IV line in FIG. 3;

FIG. 5 is a perspective view showing a set of electrode bodies included in each cell unit 100;

FIG. 6 is a diagram showing an example of a portion of an electrode tab 114 that is in contact with a laminate film 160, and an example of a portion of the laminate film 160 that is in contact with the electrode tab 114;

FIG. 7 is a sectional view showing a first modification of a connection portion between two cell units 100 arranged side by side in the first direction; and

FIG. 8 is a sectional view showing a second modification of the connection portion between the two cell units 100 arranged side by side in the first direction.

### DETAILED DESCRIPTION OF EMBODIMENTS

An embodiment and modifications according to the present disclosure will be described hereunder with reference to the drawings. In the following description, the same parts and components are designated by the same sings. The names and functions of the parts and components are also the same. Therefore, detailed description of them will not be repeated. Note that, the embodiment and modifications described below may be selectively combined as appropriate.

### Embodiment

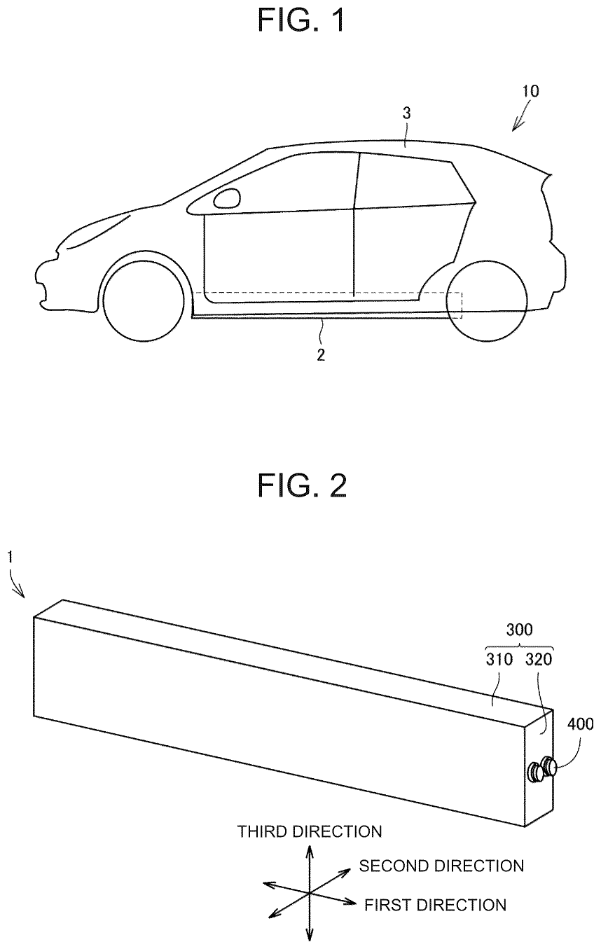

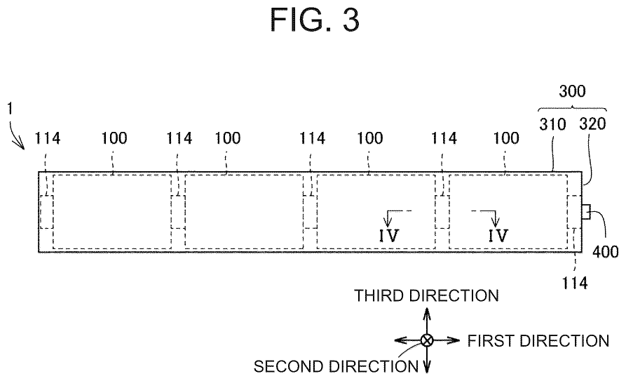

A storage cell according to the embodiment of the present disclosure will be described with reference to FIG. 1 to FIG. 6. FIG. 1 is a side view that schematically shows a vehicle equipped with a storage device including a storage cell according to the embodiment of the present disclosure. FIG. 2 is a perspective view that schematically shows the storage cell according to the embodiment of the present disclosure. FIG. 3 is a front view of the storage cell according to the embodiment of the present disclosure.

Referring to FIG. 1 and FIG. 2, a vehicle 10 includes a storage device 2 and a vehicle frame 3. The storage device 2 is disposed below a floor panel of the vehicle 10. The storage device 2 includes a plurality of storage cells 1. Examples of the vehicle 10 can include a hybrid vehicle, a plug-in hybrid vehicle, a fuel cell vehicle, and an electric vehicle.

Referring to FIGS. 2 and 3, the storage cell 1 includes a plurality of cell units 100, a cell case 300, and an external terminal 400.

In the present embodiment, the cell units 100 include eight cell units 100. More specifically, four cell units 100 are arranged side by side in the first direction, and two cell units 100 are arranged side by side in the second direction. Note that, the number of cell units 100 is not limited to eight.

The first direction can be a front-rear direction of the vehicle 10 (see FIG. 1) or a width direction of the vehicle 10. The second direction corresponds to a thickness direction of the storage cell 1. More specifically, the second direction corresponds to a lamination direction in which a cathode sheet and an anode sheet described later are laminated on each other. The third direction corresponds to a height direction of the storage cell 1. The first direction is orthogonal to both the second direction and the third direction. The second direction is orthogonal to both the first direction and the third direction. The third direction is orthogonal to both the first direction and the second direction. Each cell unit 100 has a shape that extends to be longer in the first direction than in the second direction and extends to be longer in the first direction than in the third direction. Each cell unit 100 has a shape that extends to be longer in the third direction than in the second direction.

Examples of each cell unit 100 include, for example, a lithium ion battery. Each cell unit 100 may be configured by a so-called all-solid-state battery that includes a solid electrolyte.

The cell case 300 accommodates the cell units 100. The cell case 300 is made of, for example, aluminum. The cell case 300 is formed in a rectangular parallelepiped shape elongated in the first direction.

The cell case 300 includes a case body 310 and a lid 320. The case body 310 is formed in a rectangular cylindrical shape that is elongated in the first direction. The case body 310 surrounds the cell units 100.

The lid 320 is connected to the case body 310 by welding or the like so as to block the opening of the case body 310.

The external terminal 400 is provided on the lid 320. The external terminal 400 is connected to an electrode tab 114 of the cell unit 100 located at a position closest to the lid 320 out of the cell units 100.

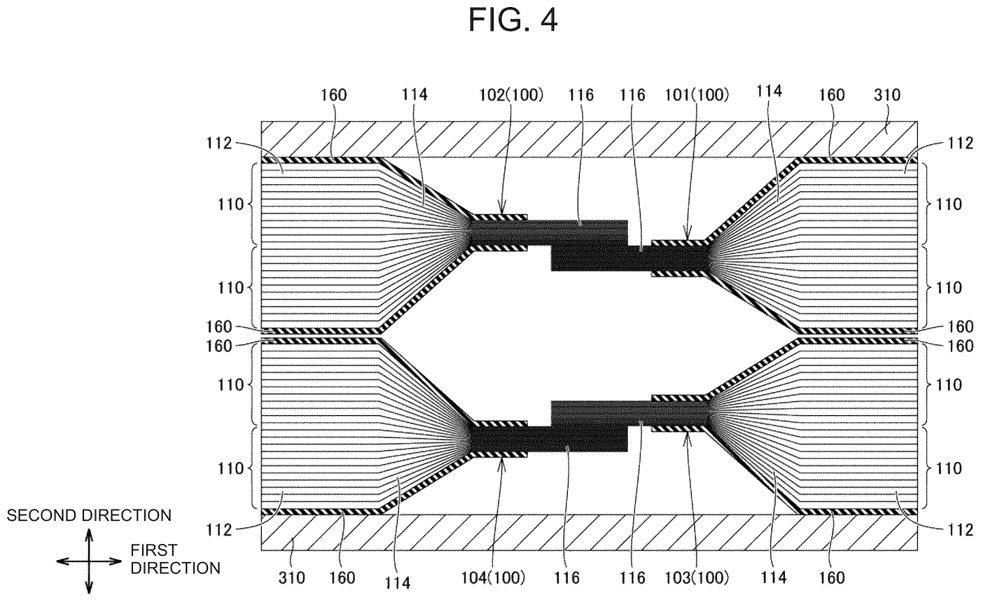

FIG. 4 is a sectional view taken along line IV-IV in FIG. 3. Referring to FIG. 4, the cell units 100 include a first cell unit 101, a second cell unit 102, a third cell unit 103, and a fourth cell unit 104.

The first cell unit 101 is connected to the second cell unit 102. The first cell unit 101 and the second cell unit 102 are arranged side by side in the first direction. The third cell unit 103 is connected to the fourth cell unit 104. The third cell unit 103 and the fourth cell unit 104 are arranged side by side in the first direction.

The first cell unit 101 and the third cell unit 103 are adjacent to each other in the second direction. The second cell unit 102 and the fourth cell unit 104 are adjacent to each other in the second direction.

Each cell unit 100 includes at least one electrode body 110 and a laminate film 160.

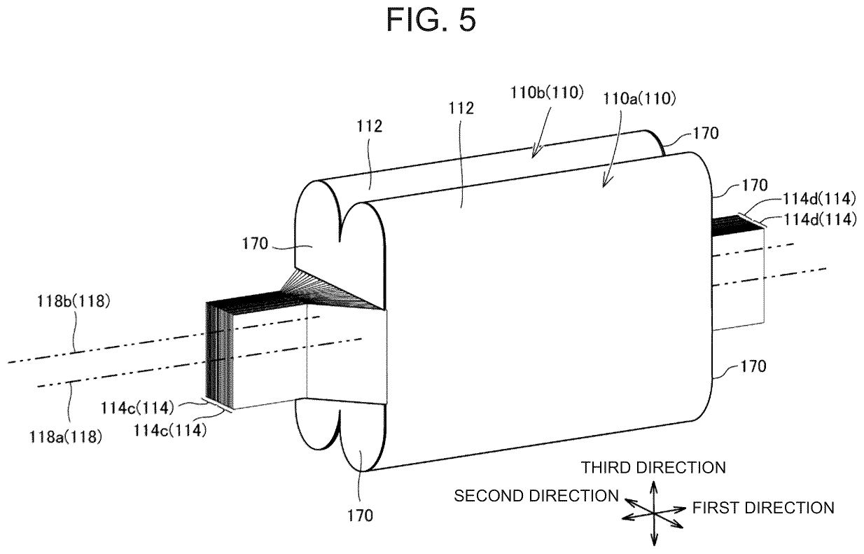

FIG. 5 is a perspective view showing a set of electrode bodies included in each cell unit 100. Referring to FIG. 5, in the present embodiment, each cell unit 100 includes two electrode bodies 110 (electrode body 110a and electrode body 110b). However, the number of electrode bodies 110 included in each cell unit 100 is not limited to two.

Each electrode body 110 is configured by a wound body in which a cathode sheet and an anode sheet are wound with a separator being interposed therebetween. Note that, in an example shown in FIG. 5, each electrode body 110 is formed by winding a cathode sheet, an anode sheet and a separator such that the cathode sheet, the anode sheet and the separator surround the periphery of a winding imaginary line 118 extending in the first direction. Therefore, each electrode body 110 includes two end faces arranged in the first direction (the direction in which the winding imaginary line 118 extends). The two end faces which are included in each electrode body 110 and arranged in the first direction are examples of “a first end face and a second end face” in the present disclosure. Note that, in these two end faces, it is possible to visually confirm a state in which each sheet is wound in a spiral shape. The two electrode bodies 110 are adjacent to each other in the second direction. The second direction corresponds to the lamination direction in which the cathode sheet and the anode sheet are laminated on each other. Each electrode body 110 is formed in a shape elongated in the first direction.

Each electrode body 110 has a coated portion 112 and an electrode tab 114. The coated portion 112 is a region of the electrode foil of the cathode sheet or the anode sheet where an active material layer is provided. The electrode tab 114 is a region of the electrode foil of the cathode sheet or the anode sheet where no active material layer is provided, that is, an uncoated portion where the electrode foil is exposed.

In each electrode body 110, at least one end face (first end face) of the two end faces arranged in the first direction has a strip-shaped electrode tab 114 formed thereon. The first direction corresponds to the short-side direction of the coated portion 112. The electrode tab 114 protrudes from the first end face in a direction in which the winding imaginary line 118 extends. Note that in the present embodiment, a plurality of electrode tabs 114 are formed. For example, with respect to the cathode sheet and the anode sheet in an unwound state before they are wound, a plurality of electrode tabs 114 are formed at intervals in a direction in which each sheet extends. In a wound state where the sheets are wound, the respective electrode tabs 114 are arranged in the second direction. However, the number of electrode tabs 114 may be one.

In the example shown in FIG. 5, the cathode tabs 114c of the electrode body 110a protrude from one end face of the two end faces arranged in the first direction of the electrode body 110a in the direction in which the winding imaginary line 118a extends. On the other hand, the anode tabs 114d of the electrode body 110a protrude from the other end face of the two end faces arranged in the first direction of the electrode body 110a in the direction in which the winding imaginary line 118a extends. Furthermore, the cathode tabs 114c of the electrode body 110b protrude from one end face of the two end faces arranged in the first direction of the electrode body 110b in the direction in which the winding imaginary line 118b extends. On the other hand, the anode electrode tabs 114d of the electrode body 110b protrude from the other end face of the two end faces arranged in the first direction of the electrode body 110b in the direction in which the winding imaginary line 118b extends.

The cathode tabs 114c of the electrode bodies 110a and 110b are gathered together at one ends of the electrode bodies 110a and 110b in the first direction. On the other hand, the anode tabs 114d of the electrode bodies 110a and 110b are gathered together at the other ends of the electrode bodies 110a and 110b in the first direction.

In each electrode body 110, an insulating coating portion 170 is provided on the end face on which the electrode tabs 114 are formed. The coating portion 170 covers a portion of the end face of the electrode body 110 on which the electrode tabs 114 are formed, no electrode tab 114 being formed at the portion. In other words, each cell unit 100 (see FIG. 4) includes the electrode body 110, the laminate film 160 (see FIG. 4), and the coating portion 170. The short-circuit in the electrode body 110 can be restrained by the coating portion 170.

Referring again to FIG. 4, in each cell unit 100, the laminate film 160 accommodates the electrode body 110 such that parts of the electrode tabs 114 of the electrode body 110 are exposed. Referring again to FIG. 5, more specifically, in a state where the electrode body 110a and the electrode body 110b are accommodated by the laminate film 160 (see FIG. 4), parts of the cathode tabs 114c of the electrode body 110a and parts of the cathode tabs 114c of the electrode body 110b are exposed at one end portions of the electrode bodies 110a and 110b in the first direction. Furthermore, in a state where the electrode bodies 110a and 110b are accommodated by the laminate film 160 (see FIG. 4), parts of the anode tabs 114d of the electrode body 110a and pars of the anode tabs 114d of the electrode body 110b are exposed at the other end portions of the electrode bodies 110a, 110b in the first direction.

Referring again to FIG. 4, the two cell units 100 arranged side by side in the first direction are connected to each other by connecting the electrode tabs 114 of the two cell units 100 together.

More specifically, exposed portions 116 of the electrode tabs 114 of the first cell unit 101, the exposed portions 116 being exposed from the laminate film 160 of the first cell unit 101 are connected, by welding or the like, to exposed portions 116 out of the electrode tabs 114 of the second cell unit 102, the exposed portions 116 being exposed from the laminate film 160 of the second cell unit 102, whereby the first cell unit 101 is connected to the second cell unit 102.

Exposed portions 116 out of the electrode tabs 114 of the third cell unit 103, the exposed portions 116 being exposed from the laminate film 160 of the third cell unit 103, are connected, by welding or the like, to exposed portions 116 out of the electrode tabs 114 of the fourth cell unit 104, the exposed portion being exposed from the laminate film 160 of the fourth cell unit 104. In this way, the third cell unit 103 is connected to the fourth cell unit 104.

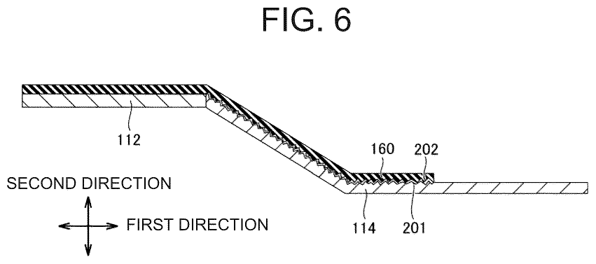

FIG. 6 is a diagram showing an example of a part of the electrode tab 114 that is in contact with the laminate film 160, and an example of a portion of the laminate film 160 that is in contact with the electrode tab 114. Referring to FIG. 6, a portion 201 of the electrode tab 114 that is in contact with the laminate film 160, and a portion 202 of the laminate film 160 that is in contact with the electrode tab 114 are subjected to rough surface processing.

Note that, at least one of the portions 201 and 202 may be subjected to rough surface processing. Furthermore, neither the portion 201 nor the portion 202 may be subjected to rough surface processing. However, when at least one of the portions 201 and 202 is subjected to rough surface processing, the laminate film 160 can be restrained from peeling off from the electrode tab 114.

As described above, the storage cell 1 according to the present embodiment includes the electrode body 110, the laminate film 160, and the coating portion 170. The electrode body 110 has the strip-shaped electrode tabs 114. The laminate film 160 accommodates the electrode body 110 such that parts of the electrode tabs 114 are exposed. The coating portion 170 is an insulating member that is provided on the end face having the electrode tabs 114 formed thereon in the electrode body 110, and covers a portion of the end surface on which no electrode tab 114 is formed.

In general, in the electrode body, elongated belt-shaped electrode tabs are formed on one side in the short-side direction of the elongated belt-shaped coated portion. Therefore, it is necessary to press the electrode tabs from both ends in the short-side direction of the end face of the electrode body and gather the electrode tabs. By pressing the electrode tabs from both the ends in the short-side direction of the end face of the electrode body, the electrode foil of the electrode tabs is pulled from both the ends in the longitudinal direction of the end face to the center portion in the longitudinal direction of the end face, so that the electrode foil may be broken or wrinkled. The short-side direction of the coated portion corresponds to the first direction described above. The short-side direction of the end face corresponds to the second direction described above. The longitudinal direction of the end face corresponds to the third direction described above.

In contrast, in the present embodiment, in each electrode body 110, strip-shaped electrode tabs 114 are formed on one side in the short-side direction (the first direction described above) of the elongated belt-shaped coating portion 112. In other words, the electrode body 110 in the present embodiment has the strip-shaped electrode tabs 114 instead of the elongated belt-shaped electrode tabs. As a result, it is possible to restrain the electrode foil of the electrode tabs 114 from being pulled when the electrode tabs 114 are gathered together. Therefore, the storage cell 1 in the present embodiment can restrain the electrode foil from being damaged and wrinkled.

Furthermore, in general, the electrode foil of the cathode sheet or the anode sheet is located on the end face of the electrode body. Therefore, when foreign matter adheres to the end face of the electrode body, there is a risk that a short circuit occurs in the electrode body. In contrast, in the present embodiment, a portion of the end face of the electrode body 110 on which the electrode tabs 114 are formed, no electrode tab 114 being formed at the portion, is covered with the insulating coating portion 170. Therefore, the storage cell 1 in the present embodiment can restrain a short circuit in the electrode body 110.

Furthermore, in the present embodiment, the two cell units 100 arranged side by side in the first direction are connected to each other by connecting the electrode tabs 114 of the two cell units 100 together. Therefore, the storage cell 1 in the present embodiment does not require a current collecting terminal or the like for connecting the two cell units 100 arranged side by side in the first direction. Therefore, the storage cell 1 in the present embodiment can reduce the number of parts required for the storage cell 1.

### First Modification

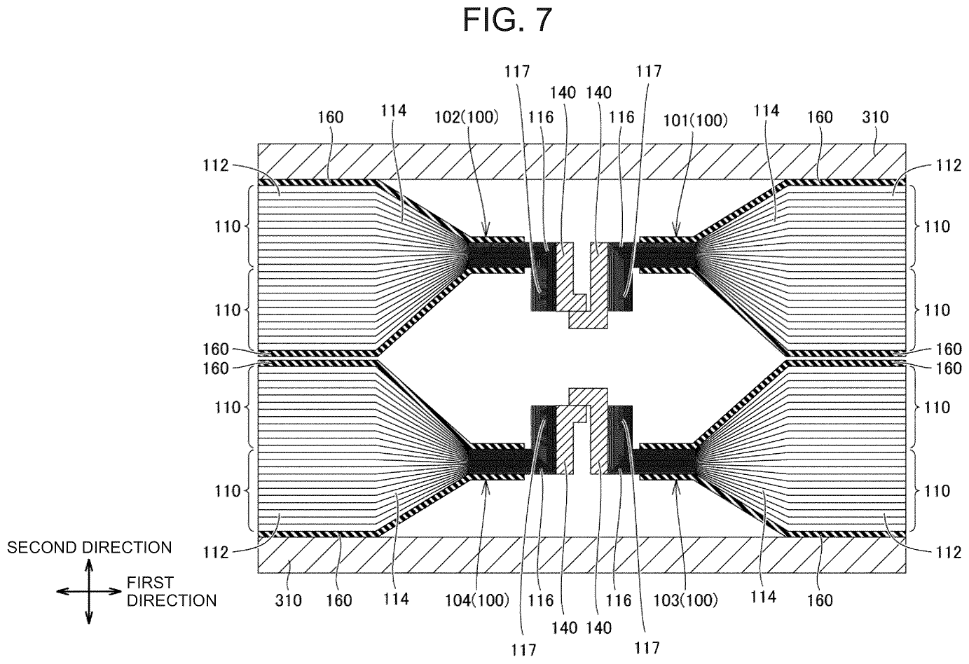

A first modification of the connection portion between the two cell units 100 arranged side by side in a first direction will be described with reference to FIG. 7. FIG. 7 is a sectional view showing the first modification of the connection portion between the two cell units 100 arranged side by side in the first direction.

In the first modification, the electrode tabs 114 are bent in a direction intersecting the extending direction of the winding imaginary line 118 (see FIG. 5) at the exposed portions 116 exposed from the laminate film 160. In the example shown in FIG. 7, the electrode tabs 114 are bent in the second direction at the exposed portions 116 thereof. However, the direction in which the electrode tabs 114 are bent at the exposed portions 116 thereof may be any direction insofar as the direction intersects the extending direction of the winding imaginary line 118, and it is not limited to the second direction.

Furthermore, in the first modification, each cell unit 100 includes an electrode body 110, a laminate film 160, and a coating portion 170 (see FIG. 5). Furthermore, in the first modification, each cell unit 100 further includes a current collecting terminal 140. The current collecting terminal 140 is connected to bent tip portions 117 of the exposed portions 116.

The current collecting terminal 140 of the first cell unit 101 is connected to the current collecting terminal 140 of the second cell unit 102 by welding or the like. The current collecting terminal 140 of the third cell unit 103 is connected to the current collecting terminal 140 of the fourth cell unit 104 by welding or the like. In other words, the first cell unit 101 is connected to the second cell unit 102 by connecting the current collecting terminal 140 of the first cell unit 101 to the current collecting terminal 140 of the second cell unit 102 by welding or the like. Furthermore, the third cell unit 103 is connected to the fourth cell unit 104 by connecting the current collecting terminal 140 of the third cell unit 103 to the current collecting terminal 140 of the fourth cell unit 104 by welding or the like.

In other respects, the first modification is similar to the above-described embodiment. As described above, in the first modification, the electrode tabs 114 are bent at the exposed portions 116 thereof. As a result, according to the first modification, the dimension in the first direction required for connecting the two cell units 100 arranged side by side in the first direction can be shortened. In other words, according to the first modification, the number of cell units 100 that can be accommodated in the storage cell 1 can be increased. Therefore, the storage cell 1 in the first modification can improve the energy density.

Furthermore, in the first modification, the current collecting terminals 140 of the two cell units 100 arranged side by side in the first direction are connected to each other by welding or the like. In general, electrode foil is easily scattered due to heat. Therefore, when the electrode tabs 114 of the two cell units 100 arranged side by side in the first direction are connected together by welding or the like, the difficulty of a work for connecting the two cell units 100 increases. In contrast, in the first modification, the current collecting terminals 140 of the two cell units 100 arranged side by side in the first direction are connected to each other by welding or the like. Therefore, according to the first modification, the two cell units 100 can be connected to each other more easily as compared with a case where the electrode tabs 114 of the two cell units 100 arranged side by side in the first direction are connected together by welding or the like.

### Second Modification

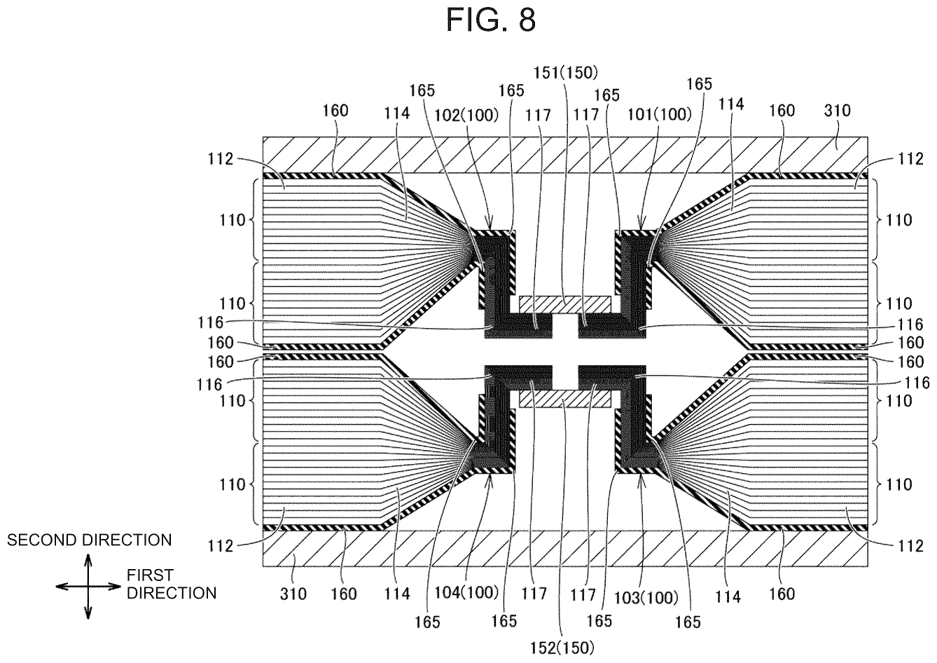

A second modification of the connection portion between the two cell units 100 arranged side by side in the first direction will be described with reference to FIG. 8. FIG. 8 is a sectional view showing the second modification of the connection portion between the two cell units 100 arranged side by side in the first direction.

In the second modification, the electrode tabs 114 are bent in a direction intersecting the extending direction of the winding imaginary line 118 (see FIG. 5) at a portion where the electrode tabs 114 are covered by the laminate film 160. More specifically, an end portion 165 of the laminate film 160 is bent in a direction intersecting the extending direction of the winding imaginary line 118. The electrode tabs 114 are bent along the laminate film 160 at the portion where they are covered by the laminate film 160. In the example shown in FIG. 8, the electrode tabs 114 are bent in the second direction at the portion where they are covered by the laminate film 160. However, a direction in which the electrode tabs 114 are bent at the portion where they are covered by the laminate film 160 may be any direction insofar as the direction intersects the extending direction of the winding imaginary line 118, and it is not limited to the second direction.

Furthermore, in the second modification, the electrode tabs 114 are further bent at the exposed portions 116 exposed from the laminate film 160. In the example shown in FIG. 8, the electrode tabs 114 are bent in the first direction (the extending direction of the winding imaginary line 118) at the exposed portions 116 thereof. However, a direction in which the electrode tabs 114 are bent at the exposed portions 116 thereof may be any direction intersecting a direction in which the electrode tabs 114 are bent at the portion where they are covered by the laminate film 160, and it is not limited to the first direction.

Furthermore, in the second modification, each cell unit 100 includes an electrode body 110, a laminate film 160, and a coating portion 170 (see FIG. 5). Furthermore, in the second modification, the storage cell 1 further includes at least one current collecting terminal 150. Current collecting terminal 151 and current collecting terminal 152 are examples of at least one current collecting terminal 150. The current collecting terminal 150 is connected to tip portions 117 of two cell units 100 arranged side by side in the first direction.

More specifically, the current collecting terminal 151 is connected to the bent tip portion 117 of the exposed portion 116 of the first cell unit 101 and the bent tip portion 117 of the exposed portion 116 of the second cell unit 102, by welding or the like. The current collecting terminal 152 is connected to the bent tip portion 117 of the exposed portion 116 of the third cell unit 103 and the bent tip portion 117 of the exposed portion 116 of the fourth cell unit 104 by welding or the like. In other words, the first cell unit 101 is connected to the second cell unit 102 via the current collecting terminal 151. Furthermore, the third cell unit 103 is connected to the fourth cell unit 104 via the current collecting terminal 152.

In other respects, the second modification is similar to the above-described embodiment. As described above, in the second modification, the electrode tabs 114 are bent at a portion where they are covered by the laminate film 160 and at the exposed portion 116. As a result, according to the second modification, it is possible to shorten the dimension in the first direction required for connecting the two cell units 100 arranged side by side in the first direction. In other words, according to the second modification, the number of cell units 100 that can be accommodated in the storage cell 1 can be increased. Therefore, the storage cell 1 according to the second modification can improve the energy density.

Furthermore, in the second modification, the two cell units 100 arranged side by side in the first direction are connected to each other via the current collecting terminal 150. Therefore, according to the second modification, the two cell units 100 can be connected to each other more easily as compared with a case where the electrode tabs 114 of the two cell units 100 arranged side by side in the first direction are connected together by welding or the like.

### Other Modifications

Each electrode body 110 may be configured by a laminate in which a cathode sheet and an anode sheet are laminated with a separator being interposed therebetween. As in the wound body, the laminate has a risk that the electrode foil may be broken or wrinkled. Furthermore, as in the wound body, in the laminate, the electrode foil of the cathode sheet or the anode sheet is located on the end surface of the electrode body. Therefore, when foreign matter adheres to the end surface of the electrode body, there is a risk of a short circuit in the electrode body. Even when each electrode body 110 is configured by the laminate in which the cathode sheet and the anode sheet are laminated with the separator being interposed therebetween, according to the above-described embodiment or the modifications, breakage and wrinkles of the electrode foil are restrained, and a short circuit in the electrode body is restrained.

The embodiment disclosed herein should be considered to be illustrative and thus not restrictive in all respects. The scope of the present disclosure is defined not by the foregoing description, but by the claims, and is intended to include all modifications in equivalent meanings to the claims and within the scope of the claims.

What is claimed is:

1. A storage cell comprising:
an electrode body having a strip-shaped electrode tab;
a laminate film that accommodates the electrode body such that a part of the electrode tab is exposed; and
an insulating coating portion that is provided on an end face of the electrode body on which the electrode tab is formed and covers a portion of the end face on which the electrode tab is not formed.

2. The storage cell according to claim 1, wherein:
the electrode body is formed so as to surround a periphery of a winding imaginary line;
the electrode body includes a first end face and a second end face that are arranged in a direction in which the winding imaginary line extends;
the electrode tab protrudes from the first end face in the direction in which the winding imaginary line extends; and
the electrode tab is bent in a direction intersecting the direction in which the winding imaginary line extends.

3. The storage cell according to claim 2, wherein:
the electrode tab is bent in a direction intersecting the direction in which the imaginary winding line extends, at an exposed portion exposed from the laminate film; and
the storage cell further comprises a current collecting terminal connected to a bent tip portion of the exposed portion.

4. The storage cell according to claim 2, wherein:
the electrode tab is bent in a direction intersecting the direction in which the winding imaginary line extends, at a portion where the electrode tab is covered by the laminate film;
the electrode tab is further bent at an exposed portion exposed from the laminate film; and
the storage cell further comprises a current collecting terminal connected to a bent tip portion of the exposed portion.

5. The storage cell according to claim 1, wherein at least one of a part of the electrode tab that is in contact with the laminate film and a portion of the laminate film that is in contact with the electrode tab is subjected to rough surface processing.
